(19) United States
(12) Patent Application Publication
(10) Pub. No.: US 2011/0197238 A1
(43) Pub. Date: Aug. 11, 2011

(54) SYSTEM AND METHOD FOR IMPLEMENTING MEDIA INTERACTION OF THE IPTV

(75) Inventors: Mujin Li, Shenzhen (CN); Xiangyu Liu, Shenzhen (CN)

(73) Assignee: ZTE Plaza, Keji Road South, Shenzhen (CN)

(21) Appl. No.: 13/123,214

(22) PCT Filed: Dec. 30, 2008
(86) PCT No.: PCT/CN08/73873

§ 371 Date: Apr. 7, 2011

(30) Foreign Application Priority Data
Oct. 7, 2008 (CN) 200810167156.3

(51) Int. Cl. H04N 7/173

(52) U.S. Cl. 725/93

(57) ABSTRACT

The present invention provides a method and a system for implementing media interaction of the IPTV. The method includes: a user terminal sending a request for a TVOD media file or a TSTV media file to a marginal stream media server in a marginal P2P area in which it resides; the marginal stream media server which is requested sending the first data block of a target media file to the user terminal; the user terminal playing the first data block of the target media file immediately after receiving the first data block of the target media file, at the same time, requesting a content delivery network agent in a P2P area of a terminal side in which the user terminal resides for an information list of content delivery network nodes capable of providing subsequent data blocks of the target media file; the content delivery network agent returning the information list of content delivery network nodes capable of providing the subsequent data blocks to the user terminal; the user terminal requesting to download and play the subsequent data blocks of the target media file. The present invention possesses advantages of high service quality, mitigating the pressure on the center stream media server and the marginal stream media server, and reducing the construction cost of the system

### FIELD OF THE INVENTION

The present invention relates to communication field, in particular to a system and method for implementing media interaction of IPTV (Internet Protocol TV).

### BACKGROUND OF THE INVENTION

For an operator, it is a challenge to provide TV On Demand (TVOD) and Time Shift TV (TSTV) services in an Internet Protocol TV (IPTV) system, especially, in a metropolitan area network (even a wide area network). With the popularization of standard definition TV and even high definition TV, the TSTV and TVOD programs of IPTV will utilize a mass of storage space. Therefore, one bottleneck must be faced is network bandwidth insufficiency if a great volume of TVOD and TSTV service of IPTV is provided in the metropolitan area network or the wide area network.

Currently, the P2P technology is used for providing services such as file download, network TV and TVOD, etc. in Internet network. Since the Internet network is a network which provides services of one performing the best, the service quality can not be guaranteed. Moreover, because various peers randomly join or leave, a user can not obtain a video quality which can meet requirements although there are various P2P algorithms for optimization in various ways.

In the prior art, the operators utilize the CDN (Content Delivery Network) to solve the transmission problem of IPTV video stream in spanning metropolitan area network or spanning wide area network, so as to provide a great volume and high quality TVOD services and TSTV services in the IPTV. When the CDN is employed to realize services, it is required to release and store the IPTV video program to a plurality of CDN nodes in advance. When a user terminal requests a service, the most appropriate node among the plurality of CDN nodes capable of providing services to the user is selected to provide the service to the user. Because the solution employs a mode based on the Client/Server (CIS), the service capability is limited by that of the server and the network bandwidth, which will directly result in a very high cost in construction and poor system extensibility. When there are a great number of online users, the users can not obtain high quality IPTV video services, which degrade the user's experience.

At present, there are no effective solutions to solve the problems of poor service quality, high system construction cost, and poor system extensibility of the IPTV system in providing the TVOD service and the TSTV service in the related art.

### SUMMARY OF THE INVENTION

Based on above description, the present invention aims to provide a system and a method for implementing media interaction of the IPTV, so as to solve the problems of high construction cost, poor service quality, and poor system extensibility of the IPTV system in providing a great volume of the TVOD service and the TSTV service.

In order to achieve the above objects, according to one aspect of the present invention, a system for implementing media interaction of the IPTV is provided.

The system for implementing Internet TV media interaction of the IPTV according to the present invention comprising: a content delivery network manager, a content delivery network agent, a center stream media server, a marginal stream media server, and a user terminal, wherein, the content delivery network manger and the center stream media server are connected to a router of a metropolitan/wide area network, the marginal stream media server is connected to a marginal router through which the metropolitan/wide area network connects with an access network to form a peer-to-peer area (P2P area) of a server side; the content delivery network agent is connected to the marginal router to which the marginal stream media server connects, the user terminal connects to the marginal router to which the marginal stream media server connects via the access network to form a P2P area of a terminal side;

the user terminal is adapted to send a request for a TVOD or a TSTV media file to a marginal stream media server of a marginal P2P area in which it is located, and play the first data block of a target media file immediately when receiving the first data block of the target media file; at the same time, the user terminal is further adapted to request, from the content delivery network agent in the P2P area of the terminal side in which it resides, an information list of content delivery network nodes capable of providing subsequent data blocks of the target media file, and sequentially request nodes in the information list to download the subsequent data blocks of the target media file according to the received information list, then play the downloaded data blocks sequentially;

the center stream media server which comprises a sub-center stream media server is adapted to store segmented media data, and send different data blocks of the segmented media data to different marginal stream media servers and store them thereof according to a content release policy;

the marginal stream media server is adapted to store the data blocks sent by the center stream media server; when receiving the request for a TVOD media file or a TSTV media file sent by the user terminal, the marginal stream medias server is adapted to send the first data block of the target media file to the user terminal according to the request; and

the content delivery network agent is adapted to perform statistics and management operation on media data distribution in the P2P area of the terminal side, and return to the user terminal the information list of the content delivery network nodes capable of providing the subsequent data blocks according to the request of the user terminal.

Preferably, when the content delivery network agent can not find the content delivery network nodes capable of providing the subsequent data blocks of the target media file in the P2P area of the terminal side in which it resides, the content delivery network agent is further adapted to notify the marginal stream media server to download the subsequent data blocks of the target media file in the P2P area of the server side;

the marginal stream media server is further adapted to request to download the subsequent data blocks of the target media file from the content delivery network manager in the P2P area of the server side according to a notification of the content delivery network agent; and

the content delivery network manager is adapted to perform statistics and management operation on media data distribution in the P2P area of the server side, and return to the marginal stream media server the information list of the content delivery network nodes capable of providing the subsequent data blocks of the target media file according to a request of the marginal stream media server.

Preferably, when the marginal stream media server fails, and the user terminal can not obtain timely services of the marginal stream media server in the P2P area of the terminal side in which the user terminal resides, the content delivery network manager is further adapted to designate a marginal stream media server which is proximate to the failing marginal stream media server, to respond the request of the user terminal and send the first data block of the target media file to the user terminal.

Preferably, the system further comprises one or more of the following means:

an electronic program guide, adapted to provide TVOD or TSTV programs for the user terminal to browse and play according to a request of the user terminal;

digital copyright management, adapted to encrypt and decrypt the segmented media data; and

service copyright management, adapted to provide account opening and authentication of TVOD service and TSTV service to the user terminal.

According to another aspect of the present invention, a method for implementing media interaction of the IPTV is provided, which can realize the pre-distribution storage of media data in advance.

The method for implementing media interaction of the IPTV according to the present invention comprising:

step A: a user terminal sending a request of for a TVOD or a TSTV media file to a marginal stream media server in a marginal P2P area in which it resides;

step B: the marginal stream media server which is requested sending the first data block of a target media file to the user terminal according to the request of the user terminal;

step C: the user terminal playing the first data block of the target media file immediately after receiving the first data block of the target media file, at the same time, requesting a content delivery network agent in a P2P area of a terminal side in which the user terminal resides for an information list of content delivery network nodes capable of providing subsequent data blocks of the target media file;

step D: the content delivery network agent returning the information list of content delivery network nodes capable of providing the subsequent data blocks to the user terminal according to a request of the user terminal; and

step E: the user terminal sequentially requesting nodes in the information list to download the subsequent data blocks of the target media file and playing downloaded data blocks sequentially.

Preferably, the steps of pre-distribution storage of media data in advance particularly comprises:

a center stream media server stores the segmented and encrypted media data; and

the center stream media server sends different data blocks of the segmented and encrypted media data to different marginal stream media servers and stores them thereof according to a content release policy.

Preferably, the above step B comprises:

when the marginal stream media server which is requested fails, a content delivery network manager designates a marginal stream media server which is proximate to the failing marginal stream media server, to respond the request of the user terminal and send the first block data of the target media file to the user terminal.

Preferably, the above step D comprises:

when the content delivery network manager can not find the content delivery network nodes capable of providing the subsequent data blocks of the target file in the P2P area of the terminal side in which it resides, it notifies the marginal stream media server to download the subsequent data blocks of the target media file from a P2P area of a server side; the marginal stream media server downloads the subsequent data blocks of the target media file from the P2P area of the server side.

Preferably, the step of the marginal stream media server downloads the subsequent data blocks of the target media file from the P2P area of the server side comprises:

the marginal stream media server sends a query request to a content delivery network manager;

the content delivery network manager returns the information list of the content delivery network nodes capable of providing the target media file to the marginal stream media server; and

the marginal stream media server requests simultaneously a plurality of nodes to in the information list to download the subsequent data blocks of the target media file according to the information list, and sends the subsequent data blocks of the downloaded target media files to the user terminal in turn.

Preferably, the above step D comprises:

when all nodes in the information list can not provide data download service, the user terminal re-sends a query request to the content delivery network agent.

Preferably, the above step E comprises:

when a user performs jump forwarding operation, if the data block located at jump forwarding location has been downloaded, the user terminal plays the data block immediately; if the data block located at jump forwarding location has not been downloaded, the user terminal downloads the data block from the marginal stream media server and plays the data block, at the same time, step C and step D are re-performed, then the user terminal plays downloaded subsequent data blocks located behind the jump forwarding position.

In virtue of the system and the method provided by the present invention, by implementing content delivery measure based on P2P in a metropolitan area network or a wide area network, and implementing P2P in an access network, and the marginal stream media server being employed in two P2P areas to transport data, the service quality provided is improved, the pressure on the center stream media server and the marginal stream media server is mitigated, and the construction cost of the system is reduced.

Other features and advantages of the present invention will be described in the following specification, and partly obvious from the description, or can be understood through implementing the present invention. The purposes and other advantages can be achieved and obtained through the structure specified by the specification, claims and drawings.

### BRIEF DESCRIPTION OF THE DRAWINGS

FIG. 1 is a schematic diagram of the structure of a system for implementing media interaction of the IPTV according to an embodiment of the present invention.

FIG. 2 is a schematic diagram of the relationship between data blocks which are used to be played initially by a user terminal in a system for implementing media interaction of the IPTV according to an embodiment of the present invention.

FIG. 3 is a schematic diagram of the relationship between data blocks which are used to be played normally by a user terminal in a system for implementing media interaction of the IPTV according to an embodiment of the present invention.

FIG. 4 is a flow chart of a method for implementing media interaction of the IPTV according to an embodiment of the present invention.

### DETAILED DESCRIPTION OF THE EMBODIMENTS

Functionality Overview

The object of the present invention is to overcome the shortcomings of the prior art, to solve the problems of high construction cost, poor service quality, and poor system extensibility occurring to the IPTV system in providing a great volume of the TVOD service and the TSTV service. The present invention sets forth implementing content delivery measure based on P2P in a metropolitan area network or a wide area network, implementing P2P in an access network, and employing the marginal stream media server in two P2P areas to transfer data, so as to provide a high quality TSTV and TVOD service for a large number of users by using less construction cost, decrease the pressure of deploying servers, reduce the deployment cost, and improve the system extensibility.

The preferred embodiments of the present invention will be described in connection with the drawings which constitute a part of the application and are intend to illustrate the principle of the present invention together with the embodiments of the present invention. For the purpose of clarity and simplicity, the particular description of the well known function and structure of the elements in the specification will be omitted for avoiding unnecessarily obscuring the key matter of the present invention.

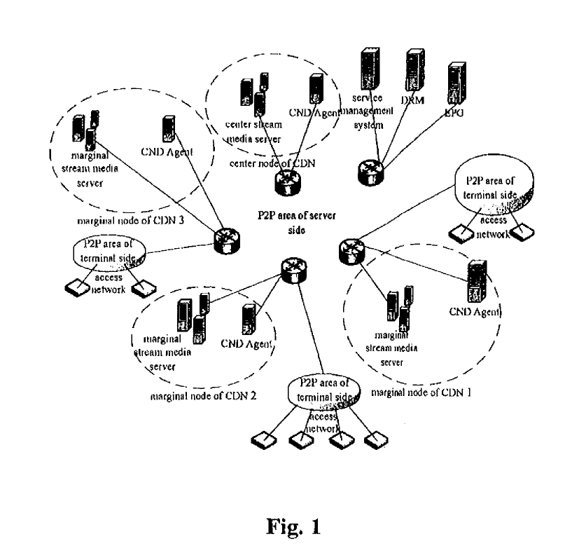

Firstly, a system for implementing media interaction of the IPTV according to an embodiment of the present invention will be described in detail in connection with FIG. 1.

FIG. 1 is a schematic diagram of the structure of the system for implementing media interaction of the IPTV according to the embodiment of the present invention. As shown in FIG. 1, the system for implementing the TVOD service and the TSTV service of the IPTV by using P2P technology provided by the embodiment of the present invention comprises: a CDN Manager, CDN Agents, stream media servers and user terminals (for example, STBs, i.e., set-top boxes). In the system, the stream media servers comprise a center stream media server (including a sub-center stream media server) and marginal stream media servers.

The CDN Manager and the center stream media server (including the sub-center media server) are connected to routers of the metropolitan area network/the wide area network. The marginal stream media servers are connected to marginal routers which connect the metropolitan area network/the wide area network and an access network, so as to form a P2P area of a server side which forms a content delivery network based on P2P. The CDN Agents and CDN nodes are in one-to-one correspondence, and are connected to the marginal routers to which the marginal stream media servers connect. The user terminals connect with the marginal routers which connect the access network and the marginal stream media servers, so as to form a P2P area of a terminal side.

Each part of the system for implementing media interaction of the IPTV of the embodiment of the present invention will be described in detail as follows.

The center stream media server is adapted to store segmented (i.e., being segmented into several data blocks) media data, wherein the operator can specify a audience rating to the stored media content, and the center stream media server can send different data blocks of the media data of the media content to different stream media servers and store them thereof according to a content release policy.

A plurality of marginal stream media servers store the media data blocks sent by the center stream media server and realize the distributed storage of the media data blocks in the marginal stream media servers according to parameters, such as audience rating, etc. of the media data blocks. Preferably, the data blocks with a high audience rating will be stored in more duplicates (so as to be convenient to provide data to terminals), while the data blocks with a low audience rating will be stored in less duplicates (so as to save storage space), this storage way can be referred to as pre-distribution storage (or content release) of the media data. Upon the completion of the pre-distribution storage, the system can begin to run.

The media data distribution in the marginal stream media server may be classified into the following two cases.

Case 1: the user terminal stores the media data being broadcasted on-demand/time-shifted. Since the storage space of the user terminal is limited, the user terminal deletes the previously stored media data according to the first-in-first-out principle when the media data being broadcasted on-demand/time-shifted gradually increases.

Case 2: when the user terminal is powered on to perform IPTV service, the marginal stream media server sends a control instruction to the user terminal to instruct it to store some media data. Upon obtaining a completed data block, the user terminal sends a state report message to the CDN Agent to report its storage state changes. The state report message may comprise the file name of the file to which the obtained data block belongs, data block number, IP address of the user terminal, and etc.

The CDN Manager is mainly adapted to perform statistics and management operation on media data distribution in the P2P area of the server side, respond a data query request from the node in the P2P area of the server side, and return a list of nodes which can provide the media data blocks, wherein a node in the list can be the center node (also referred to as the center stream media server), or the marginal node (also referred to as the marginal stream media server). The CDN Manager may send a content releasing instruction to a marginal stream media server, thus sending the media data to the marginal stream media actively. Alternatively, the CDN Manager and the center stream media server may be located in a same server physically, and in this case, they can be used as two function modules. In addition, two separate servers can be utilized to realize the roles of the CDN Manager and the center stream media server respectively.

The user terminal, which can be a STB with a built-in hard disk or a PC installed with corresponding software, obtains the media data blocks based on P2P way, and plays the obtained data blocks during the process of obtaining subsequent data blocks, so as to improve user's experience.

The CDN Agent is adapted to perform statistics and management operation on media data distribution in the P2P area of the terminal side, respond a data query request sent by the user terminal (for example, STB) in the P2P area of the terminal side, and return a list of nodes capable of providing service. The CDN Agent may send a content releasing instruction to the user terminal to actively deploy the media data to the user terminal. If there is no related media data to provide services in the P2P area of the terminal side, the CDN Agent will trigger the marginal stream media server corresponding to it to request media data from the P2P area of the server side. Alternatively, the CDN Agent and the marginal stream media server may be located in a same server physically, and in this case, they can be used as two function modules. In addition, two separate servers can be utilized to realize the roles of the CDN Agent and the marginal stream media server respectively.

Preferably, the system for implementing media interaction of the IPTV according to the embodiment of the present invention may further comprise: a Service Management System (SMS) connected to a router of the metropolitan area network/the wide area network, a Digital Rights Management (DRM) system connected to a router of the metropolitan area network/the wide area network, an Electronic Programmer Guide (EPG) connected to a router of the metropolitan area network/the wide area network.

In the above, the EPG is an entrance of the IPTV service, which can organically organize and show the service provided by the IPTV. A user can browse and optionally play a corresponding program only after entering into the EPG to which the user terminal belongs. The EPG provides functions such as searching and collecting, and etc., so as to provide a user with personalized user experience.

The SMS is mainly adapted to provide a operation supporting for the TSTV service and the TVOD service and comprises functions such as, content management, EPG management, DRM management, service management, CP/SP management, payment management, user management, authentication and authorization, charge management, statistics analysis, system management, value-added service management, and etc. The operation supporting system supports the system to which it belongs to become an operable IPTV service system by managing users, services, and resources. The user terminal can utilize the TSTV and TVOD service of the IPTV only after opening an account and being authenticated by the operation supporting system.

The DRM system is a supporting system for realizing safe delivery of the content of the operator and may comprise three function realization parts respectively for media data encryption process, user authorization process and client end decryption process. A user can decrypt and watch a media program only after being authorized.

In order to facilitate the understanding of the system for implementing media interaction of the IPTV according to the embodiment of the present invention, the particular realization process of the system for implementing media interaction of the IPTV according to the embodiment of the present invention will be illustrated by way of example as following.

When the user terminal performs the IPTV service, the user terminal is required to visit the EPG firstly and browse the media content provided by the system.

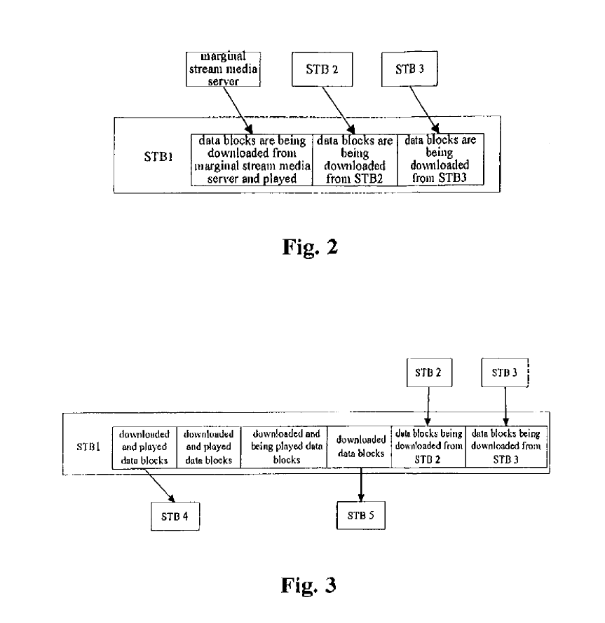

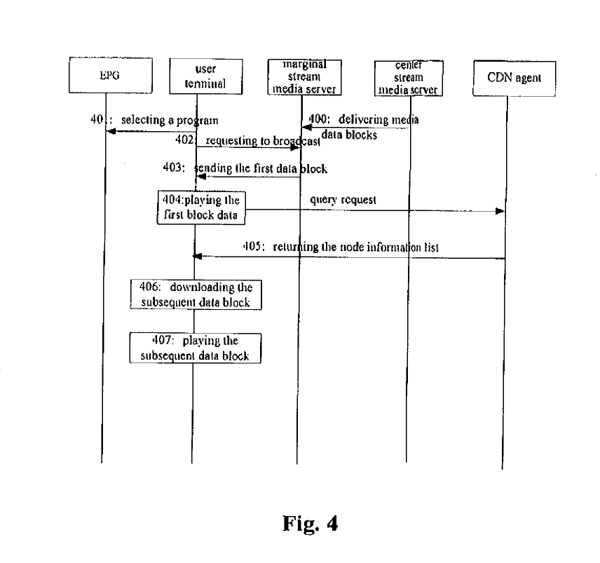

In the P2P area of the terminal side, because the user wants to experience the IPTV service when the user terminal is first turned on, pre-distribution storage can not be implemented in the P2P area of the terminal side. When the user selects one media content to watch, it is required to request the first data block of the media content from the marginal stream media server firstly. In order to reduce time delay, in the case of the marginal stream media server has not reach the upper limit of service capacity, it should respond the request of the user terminal and send the media data. The user terminal immediately plays the media data upon receiving it, at the same time, the user terminal may send a query request to the CDN Agent in the P2P area of the terminal side for the information of the nodes capable of providing the subsequent media data blocks. FIG. 2 is a schematic diagram of the relationship between data blocks which are used to be played initially by the user terminal in the system for implementing media interaction of the IPTV according to an embodiment of the present invention. As shown in FIG. 2, current user terminal (STB1) is downloading and playing data blocks from the marginal stream media server, and downloading data blocks from STB2 and STB3 at the same time. Responding the query request from the user terminal, the CDN Agent may respond the information of the nodes capable of providing service, which may be other user terminals in the P2P area of the current terminal side, or the marginal stream media servers in the P2P area of the current terminal side. The user terminal sends data requests to these nodes in sequence till it obtain service. If all of these nodes can not provide service, then the user terminal needs to make another query to the CDN Agent. Thus, with the play continues, the user terminal generally stores data blocks N+1, N+2, . . . , N+M into the hard disk while it is playing data block N, at the same time, it is receiving data blocks N+M+1, N+M+2, . . . , N+M+K of the media file. FIG. 3 is a schematic diagram of the relationship between data blocks which are used to be played normally by the user terminal in the system for implementing media interaction of the IPTV according to an embodiment of the present invention. As shown in FIG. 3, STB1 has acquired 4 data blocks, and is providing data blocks downloaded and played completely to STB4, and providing the fourth downloaded data block to STB5, and in addition, STB1 is downloading data blocks from STB2 and STB3.

By such segmenting media data into data blocks and acquiring the subsequent data blocks, downloading and playing of data blocks can be carried out at same time, so as to provide efficient service and excellent experience to users. When a user needs to perform jump forwarding, if the media data corresponding to the jump forwarding destination location has been stored in the hard disk of the user terminal, the media data of the jump forwarding destination location can be successfully played; at the same time, the user can perform XX fast forwarding operation on the media data stored in the hard disk of the user terminal. However, when the media data corresponding to the jump forwarding destination location is not in the hard disk of the user terminal, the user terminal must initiate a request for the corresponding media data to the CDN Agent immediately to obtain and play the media data, the process of which is the same with that of above mentioned play process.

When the media data of the TVOD service/the TSTV service required by the user terminal is not stored in the P2P area of the terminal side, the CDN Agent will notify the marginal stream server to download the media data from the P2P area of the server side after receiving the query request of the media data from the user terminal. The marginal stream media server firstly queries the list of nodes capable of providing the media data to the CDN Manager. The CDN Manager will return the list to the marginal stream media server, which may comprise a plurality of nodes providing the media data (the center stream media server is included in these nodes capable of providing the media data at least). The marginal stream media server will select one node from the list and request the media data from it. Preferably, the marginal stream media server may request a plurality of different data blocks from a plurality of nodes at the same time. Because the data transfer between the servers is carried out based on a metropolitan area network, the rate of obtaining data by the marginal stream media server is much greater than the required rate of playing the media data by the user terminal, which can meet the demand on the media data by the user terminal. The marginal stream media server sends a state report message to the CDN Manager and the CDN Agent after acquiring a completed data block to report changes of its storage state. The state report message comprises the file name of the file to which the acquired data block belongs, data block number, IP address of the present marginal stream media server, and etc.

Each user terminal shall report to the CDN Agent the data information provided to the external during the present operation period regularly, so that the statistics of contribution of the user terminal can be performed, so as to facilitate the resource share among the user terminals.

When the marginal stream media server fails, the user terminal will send a request to the CDN Manager when it can not obtain a timely service from the marginal stream media server in the P2P area of the terminal side. The CDN Manager will designate a marginal stream media server which is proximate to the failing marginal stream media serve to provide service to the user terminal, equalizing all the user terminals belong to the failing marginal stream media server are merged into another marginal stream media server, and the P2P area of which is extended.

A method for implementing media interaction of the IPTV according to an embodiment of the present invention will be described in connection with drawings as follows.

FIG. 4 is a flow chart of the method for implementing the TVOD service and the TSTV service by using the system for implementing media interaction of the IPTV according to the above embodiment of the present invention. As shown in FIG. 4, the particular process of the method comprises the following steps.

Step 400, the media data is pre-distributed and stored in advance, i.e., the media data which is divided into data blocks (i.e., to divide the media data into several data blocks) and encrypted by the digital rights management server is stored in the center stream media server, and an audience rating of the media data is designated by the operator. The center stream media server sends different data blocks of the media data to different marginal stream media servers and stores them thereof according to a content release policy. The media data blocks are stored in the marginal stream media servers in distribution way according to the audience rating. Preferably, the data blocks with high audience rating will be stored in a plurality of duplicates, while those with low audience rating will be stored in less duplicates.

Step 401, the user terminal browses the EPG and selects a TVOD program (or TSTV channel) to watch.

Step 402, the user terminal sends a request for a TVOD (or 1 a TSTV) media file to a marginal stream media server in a marginal P2P area to which the user terminal belongs.

Step 403, the marginal stream media server immediately responds the request for a TVOD (or TSTV) media file from the user terminal after receiving the request, and sends the first data block of the target media file. After receiving the first data block of the target media file, the user terminal immediately plays the media file and performs Step 404 at the same time.

Step 404, the user terminal sends a query request to the CDN Agent in the P2P area of the terminal side to which the user terminal belongs.

Step 405, the CDN Agent returns the information list of the CDN nodes capable of providing the subsequent data blocks to the user terminal, wherein nodes in the information list of the CDN nodes comprise other user terminals in the P2P area of the terminal side to which the user terminal belongs, and the CDN nodes further comprise the marginal stream media servers in the P2P area of the terminal side to which the user terminal belongs, which is listed in the last of the node information list.

Step 406, the user terminal sends data downloading requests to the nodes in the node information list in sequence, tilt obtains data downloading service. The user terminal sends a state report message to the CDN Agent after downloading a new data block.

If all nodes in the node information list can not provide data download service, the user terminal re-sends a query request to the CDN Agent.

Step 407, the user terminal plays the downloaded data blocks in sequence.

In above step 405, when the CDN Agent can not find a node capable of providing the subsequent media data blocks of the target media file in the P2P area of the present terminal side, it notifies the marginal media server to download the target media file from the P2P area of the server side. In particular, the process of the marginal media server downloading the target media file from the P2P area of the server side is as follows:

the marginal stream media server sends a query request to the CDN Manager;

the CDN Manager returns the information list of the nodes capable of providing the target media file to the marginal stream media server, wherein the nodes in the node information list comprise at least the center stream media server which is listed in last of the node information list, and the nodes in the node information list comprise at least other marginal stream media servers in the P2P area of the server side;

the marginal stream media server simultaneously requests a plurality of nodes in the node information list, and downloads the subsequent data blocks of the target media file, and sends the downloaded subsequent data blocks to the user terminals in sequence, wherein, the marginal stream media server sends the state report message to the CDN Manager and the CDN Agent respectively after downloading new data blocks.

In the above step 405, when the user performs jump forwarding operation, if the data block at jump forwarding destination location has been downloaded, it will be played immediately; if the data block at jump forwarding destination location has not been downloaded, the user terminal downloads it from the marginal stream media server and plays it, at the same time, steps 404-406 are re-executed, then the user terminal plays the downloaded data blocks subsequent to the jump forwarding destination location in sequence.

Based on the above description, the embodiments of the present invention provide the system and the method for implementing media interaction of the IPTV, wherein, by implementing content delivery measure based on P2P in the metropolitan area network or the wide area network, it is realized to reduce the pressure on the center stream media server, by implementing P2P in the access network, it is realized to reduce the pressure on the marginal stream media servers, at the same time, by making the marginal stream media server undertake data transfer in the two P2P areas, it is realized to alleviate the requirement on the facilities for media delivery. In addition, the present invention also provides high quality TSTV and TVOD services of the IPTV for a large number of users by using a less construction cost. Moreover, the system of the present invention can be deployed across the metropolitan area network or the wide area network. Meanwhile, the system has an excellent extensibility, wherein the more users, the less pressure for the deployed servers. Therefore, the present invention solves the problems in the related art of poor service quality, high system construction cost, and poor system extensibility occurring to the IPTV system in providing the TVOD and TSTV service.

Obviously, those skilled in the art shall understand that individual modules and steps of the present invention can be implemented with general computation devices integrated together or released in the network formed by a plurality of computation devices, alternatively implemented with program codes executable by computation devices, which can be stored in memory devices for execution by the computation devices, or make into individual integrate circuit (IC), or make several modules or steps into a single IC. Thus, the present invention is not limited to any particular combination of hardware and software.

Above description is to illustrate the preferred embodiments of the present invention not to limit the present invention. Various alterations and changes to the present invention which are apparent to those skilled in the art should be included in the scope of the present invention. Thus, the scope of the present invention should be what is claimed in the claims.

What is claimed is:

1. A system for implementing media interaction of the IPTV, comprising: a content delivery network manager, a content delivery network agent, a center stream media server, a marginal stream media server, and a user terminal, wherein, the content delivery network manger and the center stream media server are connected to a router of a metropolitan/wide area network, the marginal stream media server is connected to a marginal router through which the metropolitan/wide area network connects with an access network to form a peer-to-peer area (P2P area) of a server side; the content delivery network agent is connected to the marginal router to which the marginal stream media server connects, the user terminal connects to the marginal router to which the marginal stream media server connects via the access network to form a P2P area of a terminal side; wherein
the user terminal is adapted to send a request for a TV On Demand (TVOD) media file or a Time Shift TV (TSTV) media file to a marginal stream media server of a marginal P2P area in which it is located, and play the first data block of a target media file immediately when receiving the first data block of the target media file; at the same time, the user terminal is further adapted to request, from the content delivery network agent in the P2P area of the terminal side in which it resides, an information list of content delivery network nodes capable of providing subsequent data blocks of the target media file, and sequentially request nodes in the information list to download the subsequent data blocks of the target media file according to the received information list, then play downloaded data blocks sequentially;
the center stream media server which comprises a sub-center stream media server is adapted to store segmented media data, and send different data blocks of the segmented media data to different marginal stream media servers and store them thereof according to a content release policy;
the marginal stream media server is adapted to store the data blocks sent by the center stream media server; when receiving the request for a TVOD media file or a TSTV media file sent by the user terminal, the marginal stream media server is adapted to send the first data block of the target media file to the user terminal according to the request; and
the content delivery network agent is adapted to perform statistics and management operation on media data distribution in the P2P area of the terminal side, and return to the user terminal the information list of the content delivery network nodes capable of providing the subsequent data blocks according to the request of the user terminal.

2. The system according to claim 1, wherein when the content delivery network agent can not find the content delivery network nodes capable of providing the subsequent data blocks of the target media file in the P2P area of the terminal side in which it resides,
the content delivery network agent is further adapted to notify the marginal stream media server to download the subsequent data blocks of the target media file in the P2P area of the server side;
the marginal stream media server is further adapted to request to download the subsequent data blocks of the target media file from the content delivery network manager in the P2P area of the server side according to a notification of the content delivery network agent; and
the content delivery network manager is adapted to perform statistics and management operation on media data distribution in the P2P area of the server side, and return to the marginal stream media server the information list of the content delivery network nodes capable of providing the subsequent data blocks of the target media file according to a request of the marginal stream media server.

3. The system according to claim 1, wherein when the marginal stream media server fails, and the user terminal can not obtain timely services of the marginal stream media server in the P2P area of the terminal side in which the user terminal resides,
the content delivery network manager is further adapted to designate a marginal stream media server which is proximate to the failing marginal stream media server, to respond the request of the user terminal and send the first data block of the target media file to the user terminal.

4. The system according to claim 1, wherein the system further comprises one or more of the following means:
an electronic program guide, adapted to provide TVOD or TSTV programs for the user terminal to browse and play according to a request of the user terminal;
digital rights management, adapted to encrypt and decrypt the segmented media data; and
service copyright management, adapted to provide account opening and authentication of TVOD service and TSTV service to the user terminal.

5. A method for implementing media interaction of the IPTV, being adapted to realize the pre-distribution storage of media data in advance, the method comprising:
step A: a user terminal sending a request for a TV On Demand (TVOD) media file or a Time Shift TV (TSTV) media file to a marginal stream media server in a marginal P2P area in which it resides;
step B: the marginal stream media server which is requested sending the first data block of a target media file to the user terminal according to the request of the user terminal;
step C: the user terminal playing the first data block of the target media file immediately after receiving the first data block of the target media file, at the same time, requesting a content delivery network agent in a P2P area of a terminal side in which the user terminal resides for an information list of content delivery network nodes capable of providing subsequent data blocks of the target media file;
step D: the content delivery network agent returning the information list of content delivery network nodes capable of providing the subsequent data blocks to the user terminal according to a request of the user terminal; and
step E: the user terminal sequentially requesting nodes in the information list to download the subsequent data blocks of the target media file and playing downloaded data blocks sequentially.

6. The method according to claim 5, wherein the process of pre-distribution storage of media data in advance particularly comprises:
a center stream media server stores the segmented and encrypted media data; and
the center stream media server sends different data blocks of the segmented and encrypted media data to different marginal stream media servers and stores them thereof according to a content release policy.

7. The method according to claim 5, wherein the step B comprises:
when the marginal stream media server which is requested fails, a content delivery network manager designates a marginal stream media server which is proximate to the failing marginal stream media server, to respond the request of the user terminal and send the first data block of the target media file to the user terminal.

8. The method according to claim 5, wherein the step D comprises:
when the content delivery network agent can not find the content delivery network nodes capable of providing the subsequent data blocks of the target file in the P2P area of the terminal side in which it resides, it notifies the marginal stream media server to download the subsequent data blocks of the target media file from a P2P area of a server side; the marginal stream media server downloads the subsequent data blocks of the target media file from the P2P area of the server side.

9. The method according to claim 8, wherein the step of the marginal stream media server downloads the subsequent data blocks of the target media file from the P2P area of the server side comprises:
the marginal stream media server sends a query request to a content delivery network manager;
the content delivery network manager returns the information list of the content delivery network nodes capable of providing the target media file to the marginal stream media server; and
the marginal stream media server requests simultaneously a plurality of nodes in the information list to download the subsequent data blocks of the target media file according to the information list, and sends the subsequent data blocks of the downloaded target media files to the user terminal in turn.

10. The method according to claim 5, wherein the step D comprises:
when all nodes in the information list can not provide data download service, the user terminal re-sends a query request to the content delivery network agent.

11. The method according to claim 5, wherein the step E comprises:
when a user performs jump forwarding operation, if the data block located at jump forwarding location has been downloaded, the user terminal plays the data block immediately; if the data block located at jump forwarding location has not been downloaded, the user terminal downloads the data block from the marginal stream media server and plays the data block, at the same time, step C and step D are re-performed, then the user terminal sequentially plays downloaded subsequent data blocks located behind the jump forwarding position.

12. The system according to claim 2, wherein the system further comprises one or more of the following means:
an electronic program guide, adapted to provide TVOD or TSTV programs for the user terminal to browse and play according to a request of the user terminal;
digital rights management, adapted to encrypt and decrypt the segmented media data; and
service copyright management, adapted to provide account opening and authentication of TVOD service and TSTV service to the user terminal.

13. The system according to claim 3, wherein the system further comprises one or more of the following means:
an electronic program guide, adapted to provide TVOD or TSTV programs for the user terminal to browse and play according to a request of the user terminal;
digital rights management, adapted to encrypt and decrypt the segmented media data; and
service copyright management, adapted to provide account opening and authentication of TVOD service and TSTV service to the user terminal.

14. The method according to claim 6, wherein the step B comprises:
when the marginal stream media server which is requested fails, a content delivery network manager designates a marginal stream media server which is proximate to the failing marginal stream media server, to respond the request of the user terminal and send the first data block of the target media file to the user terminal.

15. The method according to claim 6, wherein the step D comprises:
when the content delivery network agent can not find the content delivery network nodes capable of providing the subsequent data blocks of the target file in the P2P area of the terminal side in which it resides, it notifies the marginal stream media server to download the subsequent data blocks of the target media file from a P2P area of a server side; the marginal stream media server downloads the subsequent data blocks of the target media file from the P2P area of the server side.

16. The method according to claim 15, wherein the step of the marginal stream media server downloads the subsequent data blocks of the target media file from the P2P area of the server side comprises:
the marginal stream media server sends a query request to a content delivery network manager;
the content delivery network manager returns the information list of the content delivery network nodes capable of providing the target media file to the marginal stream media server; and
the marginal stream media server requests simultaneously a plurality of nodes in the information list to download the subsequent data blocks of the target media file according to the information list. and sends the subsequent data blocks of the downloaded target media files to the user terminal in turn.

17. The method according, to claim 6, wherein the step D comprises:
when all nodes in the information list can not provide data download service, the user terminal re-sends a query request to the content delivery network agent.

18. The method according to claim 6, wherein the step E comprises:
when a user performs jump forwarding operation, if the data block located at jump forwarding location has been downloaded, the user terminal plays the data block immediately; if the data block located at jump forwarding location has not been downloaded, the user terminal downloads the data block from the marginal stream media server and plays the data block, at the same time, step C and step D are re-performed, then the user terminal sequentially plays downloaded subsequent data blocks located behind the jump forwarding position.
